(19) United States
(12) Patent Application Publication
(10) Pub. No.: US 2023/0287868 A1
(43) Pub. Date: Sep. 14, 2023

(54) Yaw Puck Load Manager

(71) Applicant: Valley Forge & Bolt & Mfg. Co., Phoenix, AZ (US)

(72) Inventors: Ronald C. Clarke, Phoenix, AZ (US); Mason Hoey, Phoenix, AZ (US)

(73) Assignee: Valley Forge & Bolt Mfg. Co., Phoenix, AZ (US)

(21) Appl. No.: 18/181,544

(22) Filed: Mar. 9, 2023

Related U.S. Application Data
(60) Provisional application No. 63/318,334, filed on Mar. 9, 2022.

(51) Int. Cl. F03D 7/02; F03D 17/00

(52) U.S. Cl. CPC F03D 7/0244; F03D 17/00; F05B 2260/902; F05B 2270/331; F16D 2066/005

(57) ABSTRACT

A system and method for monitoring and maintaining loading of a yaw brake assembly for use with windmills. A bolt assembly attaches to the yaw brake assembly and provides a compressive load to a brake piston within the yaw brake assembly. A load indicator attached to the bolt assembly provides a measurement of load applied to the brake piston by the bolt assembly.

### CROSS-REFERENCE TO RELATED APPLICATIONS

This application claims priority to U.S. provisional application Ser. No. 63/318,334, filed Mar. 9, 2022, which is incorporated herein in its entirety by reference. This application also incorporates aspects of Applicant's inventions related to Tie Rod Load Managers, U.S. patent application Ser. No. 16/792,004, and Flange Load Mangers, U.S. patent application Ser. No. 17/382,302, both of which are incorporated herein in their entirety by reference.

### BACKGROUND

Wind turbines are regularly repositioned to generate the maximum amount of energy based on wind conditions. In general, the nacelle is moved to face the prevailing wind (yaw control), while the blades are angled correctly depending on factors like wind velocity (pitch control). The yaw system controls the orientation of the wind turbine rotor towards the wind. Active yaw systems are considered to be the state of the art and generally include a means of rotatable connection between nacelle and tower (yaw bearing), a means of active variation of the rotor orientation (i.e., yaw drive), a means of restricting the rotation of the nacelle (yaw brake) and a control system that processes the signals from wind direction sensors (e.g. wind vanes) and provides corresponding commands to the actuating mechanisms.

In order to stabilize the yaw bearing against rotation and oscillating forces, a means of braking is necessary, e.g., by applying a constant small counter-torque at the yaw drives in order to eliminate the backlash between gear-rim and yaw drive pinions and to prevent the nacelle from oscillating due to the rotor rotation and wind gusts. The most common solution is the implementation of a hydraulically-actuated disk brake that typically includes flat circular brake disks and a plurality of brake calipers (8-12 spaced calipers) with hydraulic pistons and brake pads. The hydraulic yaw brakes fix the nacelle in position thus relieving the yaw drives from unnecessary loads and oscillation.

The yaw brake pads and the disc can be released when nacelle adjustments are made to optimize wind generation. The brakes are released to let the yaw motors turn the nacelle sufficiently into the optimal wind direction, and then reapplied to the hold position. As these brake pads wear, supporting hardware must often be adjusted or re-torqued to ensure proper function.

Brake maintenance is difficult and costly for several reasons:

Braking is automatically controlled.

Brakes must operate unmanned for extended periods.

Brakes must achieve high standards of reliability with extended service periods.

Brakes must operate under extreme conditions as in desert, ocean, or arctic regions.

Windmills can be sited offshore in salt atmospheres, high humidity, and temperature extremes, and the brakes must withstand these harsh conditions.

Brakes are located high above ground and sea level, making access difficult for maintenance.

Accordingly, improvements are needed in yaw brake operation and maintenance.

### SUMMARY OF THE INVENTION

While the way that the present invention addresses the disadvantages of the prior art will be discussed in greater detail below, in general, the present invention provides

One objective of the present invention is to continuously hold a Friction Puck target load within a set load window. This is accomplished with an on-board method of torquing the Friction Puck loading screw. This is accomplished by reducing friction to low values by using a thrust bearing and a ball screw driven by a worm reducer or reduction gear motor drive. This offers advantages of continuously efficient Yaw Puck operation, longer friction lining puck life and fewer maintenance inspections.

One embodiment is configured for use with Valley Forge's snap on (SPC4) probes to obtain either hard-wired or wireless load information to a base module in the Nacelle. A yaw puck assembly is mounted adjacent a slew ring atop a windmill to provide continuous resistance to movement of the nacelle. This resistance is selected to prevent oscillation or rotation during windmill operation, but to allow repositioning as needed to optimize for wind direction. Load monitoring at the yaw puck allows for timely retorquing as needed to maintain the desired resistance.

An anchor pin in contact with the moveable brake piston extends through a Bellville washer stack is housed within the yaw puck such that compression of the washer stack results in linear movement of the upper portion of the anchor pin. The anchor pin further extends through a bolt assembly configured to provide a compressive downward force on the brake piston. The bolt assembly can be tightened to a desired brake piston loading, the anchor pin position is then measured and the system calibrated to accurately measure subsequent load variation. Movement at the upper portion of the anchor pin is converted into a rotational movement by a cam positioned to respond to movement of the upper portion of the anchor pin. This rotational movement is then converted into linear movement of a load indicator surface relative to a fixed datum surface, which movement can be measured to determine instantaneous and ongoing loading of the brake piston.

The bolt assembly attaches to, i.e., threads into, a top portion of the yaw puck assembly to compress the Bellville washer stack. A load indicator further attaches to, e.g., threads onto, the bolt assembly and presents a datum surface and load indicator surface for relative measurement of real-time loading on the brake system.

Phase 1. The present embodiment uses proprietary load indicating systems that cooperate with existing yaw brake hardware and customer designs to proportion deflection of a Belleville washer stack into a 0-5 thousandth pin travel for use with Applicant's load indicating probes. In an alternative embodiment, the Belleville stack deflection may be measured directly using an LVDT or an electronic dial indicator's signal.

To convert Belleville washer stack deflection into load information, the washer stack is measured to establish a curve using an Spc4 bolt to compress the Belville washers while plotting deflection against load, using the curve data to design the corresponding Cam to convert linear deflection from washer stack compression into rotational movement that can be then be converted into linear deflection useful to an Spc4-style reader.

The Cam concept functions most efficiently when operating clearances are reduced to nearly zero, e.g., using ball and linear bearings to maintain zero backlash. Clearances in the Belleville washer stack area are not as critical given expected tolerances of around 0.250″ max travel.

A “Sleeve Pin” or “Anchor Pin” is configured with sufficient length, OD and ID clearance to move up and down easily within the Bellville washer stack and yaw puck assembly to provide a deflection reference for a load indicator mounted on the yaw puck. A sleeve displacement Transfer Block and connecting hardware is connected between the fixed Anchor Pin and a Datum Disc Carrier. The Transfer Block stays aligned to the Datum Disc Carrier via linear bearings and has sufficient thread clearance with the sleeve.

Under normal conditions, the brake pad carrier should not turn, being held by the effects of the friction pad. The brake pad carrier could support a woven composite brake pad. A Fixed Center Pin (and attached components), is attached so that the pad carrier can rotate inside the enclosure if needed, e.g., with the top cap only in contact with the enclosure tube against a light dust seal.

A Con Rod defines flat faces to prevent the gage pin from turning.

The datum disc can be screwed up and down to find Zero and locked with a set screw.

For assembly purposes a setting pin is used to locate the angular position of the Cam with the Con Rod while setting the gage pin to zero. The datum is then ground to flush to read zero and the angular position of the Cam is maintained in place by locking shaft collars.

One aspect of the invention features, in some embodiments, a yaw brake load indicator for use with a yaw brake assembly with a piston brake configured to apply a braking force to a rotatable component of a windmill. The yaw brake load indicator includes a bolt assembly configured to apply a load to the brake piston of the yaw brake assembly and a load indicator attached to at least one of the bolt assembly and the yaw brake assembly to measure the load applied by the bolt assembly on the brake piston.

In some embodiments, the yaw brake load indicator further includes an anchor pin disposed between the brake piston and load indicator to translate brake piston position into a measure of yaw brake load.

In some embodiments, the yaw brake load indicator further includes a cam and a cam roller pin to translate anchor pin movement into rotational cam movement and rotational cam movement back into linear movement of the cam roller pin relative to a datum surface as a measure of load applied to the yaw brake assembly.

In some embodiments, the yaw brake load indicator further includes a fixed block attached to the anchor pin and a travel block axially offset from the fixed block, the fixed block supporting the cam and the travel block supporting a connector rod coupled to the cam to translate axial movement of the anchor pin into rotational cam movement. In some embodiments, the anchor pin extends axially from the brake piston, through a Bellville washer stack and thrust piston in the yaw brake assembly, through the bolt assembly, and into the load indicator.

Another aspect of the invention features, in some embodiments, a yaw puck assembly and load indicator for monitoring loading of a yaw brake on a windmill. The yaw puck assembly is configured to mount adjacent a rotatable member of a windmill and includes a brake wear surface. A bolt assembly is attachable to the yaw puck assembly and configured to apply a load to a brake wear surface of the yaw puck assembly. A load indicator is attachable to the bolt assembly and responsive to movement of an anchor pin extending between the yaw puck assembly, through the bolt assembly, and to the load indicator.

In some embodiments, the load indicator further includes a cam, cam roller pin, and datum surface configured such that axial movement of the anchor pin results in rotational movement of the cam and rotation of the cam results in axial movement of the cam roller pin relative to the datum surface as an indication of loading applied to the brake wear surface by the bolt assembly.

Another aspect of the invention, features in some applications, a method of monitoring loading on a yaw brake assembly including a brake piston. The method includes torquing a bolt assembly attached to the yaw brake assembly to apply an initial load to the brake piston and
measuring deflection of an anchor pin extending between the brake piston and a load indicator attached to at least one of the bolt assembly and the yaw brake assembly.

In some applications, the method includes translating linear deflection of the anchor pin into rotational cam movement; translating rotational cam movement into linear cam roller pin movement; and
measuring movement of the cam roller pin relative to a datum surface to determine loading of the brake piston.

Another aspect of the invention, features in some applications, a method of maintaining loading for a yaw brake assembly. The method includes torquing a bolt assembly attached to the yaw brake assembly; monitoring loading via a load indicator attached to the yaw brake assembly; and
periodically retorquing the bolt assembly to within a desired load window.

In some applications, the load indicator is configured for use with an SPC4-type load reader.

In some applications, the load indicator is configured with an anchor pin, cam, cam roller pin, and datum surface and wherein monitoring loading comprises the cam and cam roller pin cooperating to convert axial movement of the anchor pin into rotational movement of the cam and rotational movement of the cam into axial movement of the cam roller pin.

Thus, load monitoring may be used to reset or maintain yaw brake loading at a desired threshold throughout the wear life of the brake pads. This load monitoring can be performed remotely and the torquing of the system may be further automated to provide remote maintenance. This offers significant savings in terms of operation and maintenance of the yaw brake system.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures:

FIG. 1 illustrates perspective view of a yaw puck brake assembly with an attached load indicator according to one embodiment;

FIG. 2 illustrates a side view of the yaw puck brake assembly with the attached load indicator of FIG. 1;

FIG. 3 illustrates a cross-sectional view of FIG. 2, along line A-A;

FIG. 4 illustrates an exploded view of the yaw puck brake assembly with the attached load indicator of FIGS. 1-3;

FIG. 5 illustrates an axially exploded view of the yaw puck brake assembly with the attached load indicator of FIGS. 1-4;

and

FIG. 6 illustrates an exploded view of the load indicator of FIGS. 1-4.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured rotating devices or braking systems having different shapes, components, drive or brake mechanisms and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

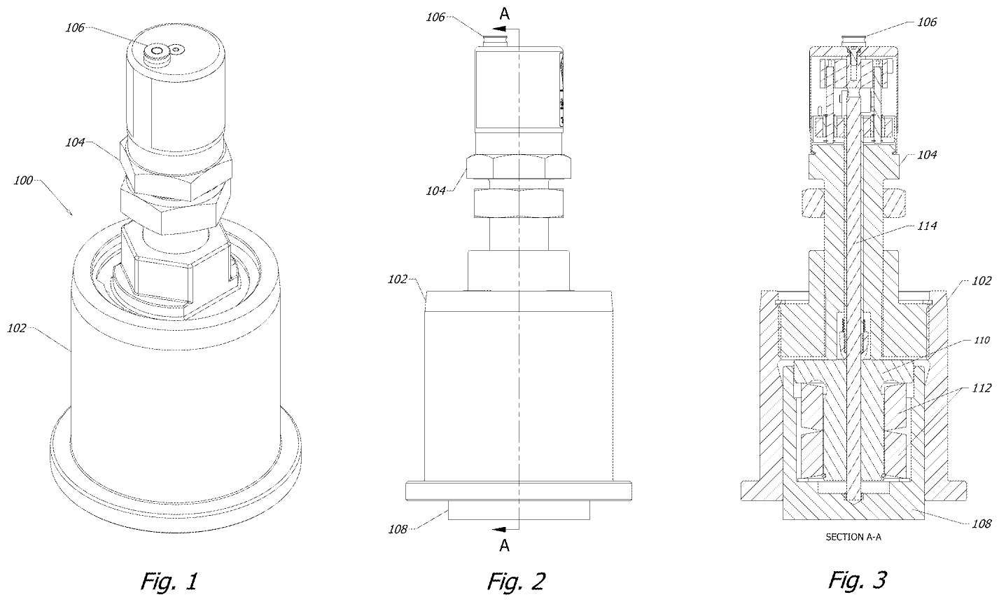

FIGS. 1-6 illustrate different views of a load indicating device for use with a yaw puck brake system. Windmills generally include a series of brake calipers or yaw brake assemblies spread around a yaw brake ring or “slew ring.”

With reference now to FIGS. 1-2, according to various embodiments, a load indicating yaw brake assembly 100 includes a yaw brake assembly 102 compressable by a bolt assembly 104 attached thereto, and a load indicator assembly 106 coupled to the bolt assembly. Load indicator assembly 106 is responsive to loading applied to the yaw brake assembly 102 by bolt assembly 104.

With reference now to FIG. 3, yaw brake assembly 102 includes a thrust piston 110 for compressing a Bellville washer stack 112 to press a brake piston 108 into contact with a braking slew ring (not shown). Bolt assembly 104 threads or otherwise attaches to the brake assembly 102 to apply a compressive force to the thrust piston 110 and in turn to Belville washer stack 112 and brake piston 108. Load indicator assembly 106 is coupled to bolt assembly 104 to measure deflection of anchor pin 114 under load. Anchor pin 114 extends from the brake piston 108 through Bellville washer stack 112, thrust piston 110, and bolt assembly 104 to load indicator assembly 106.

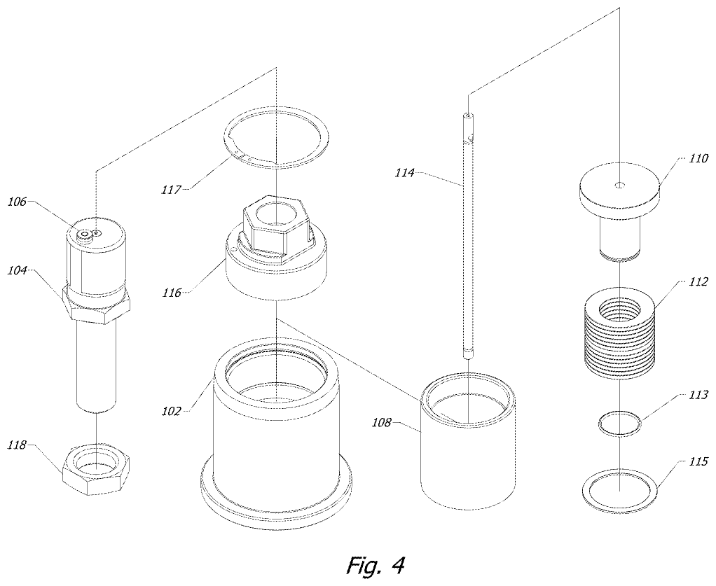

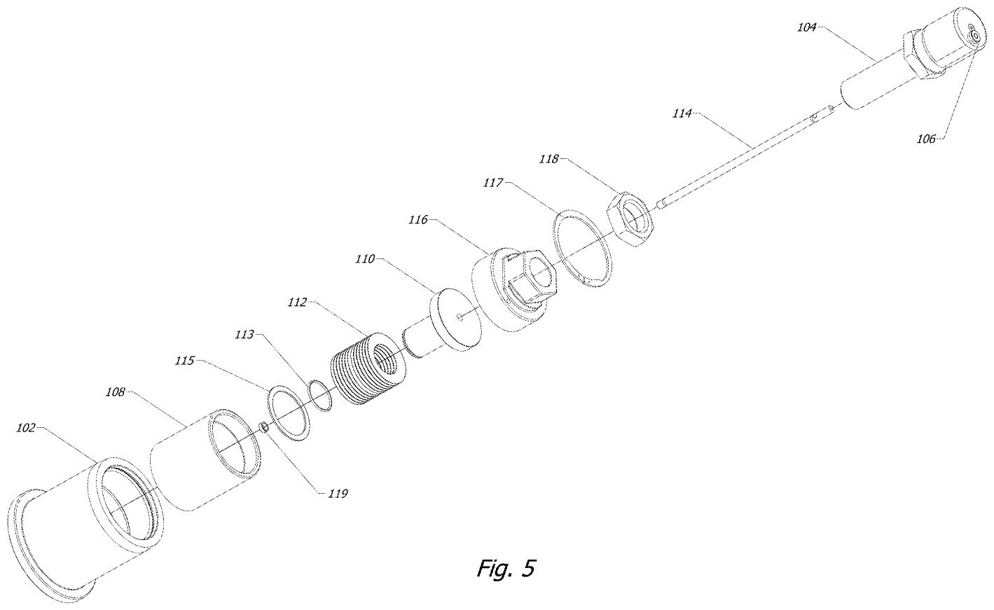

With reference now to FIGS. 4-5, yaw brake assembly 102 houses brake piston 108, which has a closed or semi-closed bottom to support the lower end of anchor pin 114 and the compressive forces applied by the thrust piston 110 through Belville washer stack 112. A threaded cap 116 is secured to the top of the yaw brake assembly 102, e.g., via threading or via a retaining ring 177, to secure the internal components of the yaw brake assembly 102. A jam nut 118 serves to lock bolt assembly 104 in position atop yaw brake assembly 102 with a selected compressive force applied to brake piston 108.

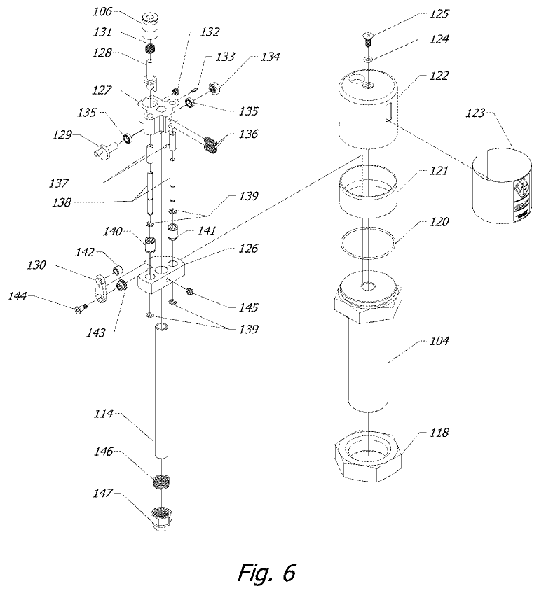

With reference now to FIG. 6, an exploded view of load indicator assembly 106 shows load indictor housing base 26 configured to couple load indicator assembly 106 atop bolt assembly 104, e.g., via a threaded coupling, with an o-ring 28 therebetween. Housing base 26 and a housing cap 24 together house various load indicator components. Anchor pin 114 extends from the yaw brake assembly 102 through the bolt assembly 104 and into the load indicator assembly 106. A fixed block 8 is secured to the upper portion of anchor pin 114 via set screws 18. Fixed block 8 supports a pair of linear shafts 14 extending downward from fixed block 8 to a travel block 3, secured by a pair of shaft collars 17.

Travel block 3 supports a connector rod 5 via a connector rod pin 4 and screw 7. Connector rod 5 is further connected to an offset cam 15 that serves to turn linear movement of anchor pin, and thereby travel block 3, into rotational movement. Cam 15 is supported by fixed block 8 and urges cam roller pin 12 up and down in response to rotation of cam 15. Cam roller pin 12 supports a ball bearing 10 in contact with cam 15 to provide low-friction responses to movement of anchor pin 114 and travel block 3. An upper end of cam roller pin 12 is calibrated to a datum surface 11 (e.g., SPC4-type), such that movement of the upper end of cam roller pin 12 relative to datum surface 11 provides an indication of deflection of anchor pin 114. A cam roller spring 13 serves to maintain contact between cam 15 and ball bearing 10 on cam roller pin 12.

Accordingly, the present invention provides a system and method of monitoring and maintaining loading in a yaw brake assembly for windmills and similar braking systems.

Similarly, while the present invention has been described herein as a braking apparatus and means for preventing rotation, the present invention may be readily used with any number of other devices now known or hereafter developed where load monitoring is necessary or userful.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A yaw brake load indicator for use with a yaw brake assembly with a piston brake configured to apply a braking force to a rotatable component of a windmill, the yaw brake load indicator comprising:
a bolt assembly configured to apply a load to the brake piston of the yaw brake assembly; and
a load indicator attached to at least one of the bolt assembly and the yaw brake assembly to measure the load applied by the bolt assembly on the brake piston.

2. The yaw brake load indicator of claim 1, further comprising an anchor pin disposed between the brake piston and load indicator to translate brake piston position into a measure of yaw brake load

3. The yaw brake load indicator of claim 2, further comprising a cam and a cam roller pin to translate anchor pin movement into rotational cam movement and rotational cam movement back into linear movement of the cam roller pin relative to a datum surface as a measure of load applied to the yaw brake assembly.

4. The yaw brake load indicator of claim 3 further comprising a fixed block attached to the anchor pin and a travel block axially offset from the fixed block, the fixed block supporting the cam and the travel block supporting a connector rod coupled to the cam to translate axial movement of the anchor pin into rotational cam movement.

5. The yaw brake load indicator of claim 4, where the anchor pin extends axially from the brake piston, through a Bellville washer stack and thrust piston in the yaw brake assembly, through the bolt assembly, and into the load indicator.

6. A yaw puck assembly and load indicator for monitoring loading of a yaw brake on a windmill, comprising:
a yaw puck assembly configured to mount adjacent a rotatable member of a windmill and comprising a brake wear surface;
a bolt assembly attachable to the yaw puck assembly and configured to apply a load to a brake wear surface of the yaw puck assembly; and
a load indicator attachable to the bolt assembly and responsive to movement of an anchor pin extending between the yaw puck assembly, through the bolt assembly, and to the load indicator.

7. The load indicator of claim 11, further comprising a cam, cam roller pin, and datum surface configured such that axial movement of the anchor pin results in rotational movement of the cam and rotation of the cam results in axial movement of the cam roller pin relative to the datum surface as an indication of loading applied to the brake wear surface by the bolt assembly.

8. A method of monitoring loading on a yaw brake assembly including a brake piston, the method comprising:
torquing a bolt assembly attached to the yaw brake assembly to apply an initial load to the brake piston; and
measuring deflection of an anchor pin extending between the brake piston and a load indicator attached to at least one of the bolt assembly and the yaw brake assembly.

9. The method of claim 6, further comprising translating linear deflection of the anchor pin into rotational cam movement;
translating rotational cam movement into linear cam roller pin movement; and
measuring movement of the cam roller pin relative to a datum surface to determine loading of the brake piston.

10. A method of maintaining loading for a yaw brake assembly comprising:
torquing a bolt assembly attached to the yaw brake assembly;
monitoring loading via a load indicator attached to the yaw brake assembly; and
periodically retorquing the bolt assembly to within a desired load window.

11. The method of claim 8 wherein the load indicator is configured for use with an SPC4-type load reader.

12. The method of claim 8 wherein the load indicator is configured with an anchor pin, cam, cam roller pin, and datum surface and wherein monitoring loading comprises the cam and cam roller pin cooperating to convert axial movement of the anchor pin into rotational movement of the cam and rotational movement of the cam into axial movement of the cam roller pin.
